(19) United States
(12) Patent Application Publication
(10) Pub. No.: US 2020/0127345 A2
(43) Pub. Date: Apr. 23, 2020

(54) TEMPERATURE CONDITIONING UNIT, TEMPERATURE CONDITIONING SYSTEM, AND VEHICLE

(71) Applicant: Panasonic Intellectual Property Management Co., Ltd., Osaka (JP)

(72) Inventors: SHIZUKA YOKOTE, Osaka (JP); TAKASHI OGAWA, Osaka (JP); MICHIHIRO KUROKAWA, Osaka (JP); MASAHITO HIDAKA, Osaka (JP); KOJI KUYAMA, Hyogo (JP)

(21) Appl. No.: 15/574,568

(22) PCT Filed: Jul. 14, 2016
(86) PCT No.: PCT/JP2016/003325

§ 371 Date: Nov. 16, 2017

(30) Foreign Application Priority Data
Jul. 24, 2015 (JP) 2015-146698

(51) Int. Cl. H01M 10/625; F04D 25/10; F04D 25/06; F04D 29/40; H01M 10/613; H01M 10/63; H01M 10/6563

(52) U.S. Cl. CPC H01M 10/625; F04D 25/10; F04D 25/06; B60K 2001/005; H01M 10/613; H01M 10/63; H01M 10/6563; F04D 29/403

(57) ABSTRACT

Temperature conditioning unit (10) includes impeller (110), rotary drive source (200), fan case (120), housing (300), and at least one of intake side chamber (311a) at an object to be temperature conditioned and an exhaust-side chamber at the object to be temperature-conditioned. Impeller (110) has substantially disk-shaped impeller disk (112) that includes a rotating shaft in its center and is disposed on a plane perpendicular to the rotating shaft, and a plurality of rotor vanes (111) erected on an intake-hole-end surface of impeller disk (112). Rotary drive source (200) includes shaft (210) and is connected to impeller (110) via shaft (210). Fan case (120) has substantially cylindrical side wall (121) formed to be centered about the rotating shaft, intake hole (122) that is circular on a plane perpendicular to the rotating shaft and is centered about the rotating shaft, and discharge hole (123) positioned on an opposite end of the side wall from intake hole (122) in a direction along the rotating shaft. Housing (300) includes an outer surface mounted with fan case (120) and accommodates the object to be temperature-conditioned.

### TECHNICAL FIELD

The present invention relates to a temperature conditioning unit and a temperature-conditioning system that temperature condition an object to be temperature conditioned and also relates to a vehicle equipped with the temperature conditioning unit or the temperature conditioning system. The present invention relates more particularly to a temperature conditioning unit, a temperature conditioning system or the like that temperature conditions a power storage device or an inverter device that is mounted to a vehicle such as an electric vehicle or a hybrid vehicle.

### BACKGROUND ART

In a vehicle that is mounted with a plurality of power sources including a secondary battery, such as a hybrid vehicle, secondary battery cells produce heat because of current passing through the battery during charge and discharge, internal resistance of the battery cells, and contact resistance of cell connectors. Temperature of the secondary battery greatly affects a life of the secondary battery. Blowing air of ordinary temperature or the like for cooling the battery cells or warming the battery cells under extremely low temperature conditions is very important in improving output of a battery system and reducing a number of cells.

However, securing internal space of the vehicle sets a limit to securement of a sufficiently ample mounting area for the secondary battery, so that the plurality of battery cells is arranged inside a housing of limited size. Air-blowing using a forced air-cooling means for air-cooling is generally carried out to temperature-condition the secondary battery which is an object to be temperature-conditioned. It is as a matter of course that increases in output density of the battery demands increase in output of a device such as a temperature conditioning unit or a temperature conditioning system. The increase in the device's output tends to cause increase in size of the device. On the other hand, there is a demand for size reduction of the device. Thus, it goes without saying that seeking the increase in the device's output and the size reduction of the device at the same time is a highly difficult subject.

A centrifugal blower that uses a scroll casing, such as shown in PTL 1 or PTL 2, is often used in a conventional cooling device for a vehicle-mounted secondary battery. In the centrifugal blower using the scroll casing, a casing exit requires a measurable straight passage. Accordingly, a distance from a housing to the blower increases, so that an ample mounting area is required. Moreover, a flow discharged from an impeller (centrifugal fan) is drawn outward along a scroll side wall. For this reason, a flow uniforming mechanism such as a flow dividing duct is required to uniform temperature distribution inside the housing. These points are problematic when further size reduction is sought.

FIG. 12 is a sectional view of a conventional temperature conditioning unit. Object 350 to be temperature-conditioned is accommodated by housing 310 of the conventional temperature conditioning unit shown in FIG. 12. Air discharged from forward-curved fan 400 is integrated circumferentially inside scroll casing 1120. Scroll casing 1120 is such that a distance from rotating shaft 1112a to side wall 1121 gradually increases. Thus, flow 301 of the air discharged from forward-curved fan 400 is drawn toward inner-circumferential surface 1121a of side wall 1121. Accordingly, flow uniforming mechanism 1310 such as duct 1311 needs to be mounted inside housing 310 to uniform air flow 301 that is fed into housing 310.

However, centrifugal blower 1100 using forward-curved fan 400 causes long distance L from its center of gravity G to discharge hole 1123. Temperature conditioning unit 1010 thus becomes badly balanced and unstable when this centrifugal blower 1100 is mounted to housing 310. Accordingly, temperature conditioning unit 1010 is fixed to a peripheral member via mounting parts 1124. In this case, a variety of shape variations are required of mounting parts 1124 for adaptation of temperature conditioning unit 1010 to an environment where temperature conditioning unit 1010 is used.

Especially in cases where flow uniforming mechanism 1310 is formed separately from housing 310, a distance from center of gravity G to flow uniforming mechanism 1310 needs to be considered. Generally, the distance from center of gravity G to flow uniforming mechanism 1310 becomes long, so that the temperature conditioning unit becomes more badly balanced.

In a conventional method, a blower mechanism is disposed near a heat generator when the air is blown against object 350 to be temperature-conditioned (refer to PTL 3). However, in an electric apparatus in which an object to be temperature-conditioned is large with respect to a housing with a plurality of heat generators being densely disposed, air flow resistance, that is to say, pressure loss increases.

In a conventional temperature conditioning unit, a housing has high ventilation resistance, so that high output is required of a blower mechanism, thus naturally causing increase in size of the blower mechanism. Consequently, it is difficult to accommodate the blower mechanism in the housing. As such, a blower mechanism is placed externally to a housing, and a passage is generally formed by a duct or the like that connects a discharge hole of a blower and an inflow port of the housing (refer to PTL 4). For this reason, it is difficult to achieve size reduction of the electric apparatus including the object to be temperature-conditioned and a temperature conditioning system.

### CITATION LIST

### Patent Literatures

PTL 1: Unexamined Japanese Patent Publication No. H10.093274

PTL 2: Unexamined Japanese Patent Publication No. 2010.080134

PTL 3: Unexamined Japanese Patent Publication No. H10.093274

PTL 4: Japanese Patent No. 4366100

### SUMMARY OF THE INVENTION

To solve the above problems, a temperature conditioning unit according to the present invention includes an impeller, a rotary drive source, a fan case, a housing, and at least one of an intake-side chamber at an object to be temperature-conditioned and an exhaust-side chamber at the object to be temperature-conditioned. The impeller has an impeller disk that is substantially disk-shaped, includes a rotating shaft in its center and is disposed on a plane perpendicular to the rotating shaft, and a plurality of rotor vanes erected on an intake-hole-end surface of the impeller disk. The rotary drive source includes a shaft and is connected to the impeller via the shaft. The fan case has a side wall that is substantially cylindrical and is formed to be centered about the rotating shaft, an intake hole that is circular on a plane perpendicular to the rotating shaft and is centered about the rotating shaft, and a discharge hole positioned on an opposite end of the side wall from the intake hole in a direction along the rotating shaft. The housing includes an outer surface mounted with the fan case and accommodates the object to be temperature-conditioned.

According to the present invention described above, the temperature conditioning unit that can be provided is of small size and is capable of efficient air-blowing even with respect to the housing containing densely disposed components.

### BRIEF DESCRIPTION OF DRAWINGS

FIG. 1A is a sectional view of a temperature conditioning unit according to a first exemplary embodiment of the present invention.

FIG. 1B is a perspective view of the temperature conditioning unit according to the first exemplary embodiment of the present invention.

FIG. 1C is an enlarged view of an essential portion of the temperature conditioning unit shown in FIG. 1A.

FIG. 2 is a sectional view illustrating another structural example of the temperature conditioning unit according to the first exemplary embodiment of the present invention.

FIG. 3 is a perspective view of an object to be temperature conditioned according to the first exemplary embodiment of the present invention.

FIG. 4 is a sectional view illustrating still another structural example of the temperature conditioning unit according to the first exemplary embodiment of the present invention.

FIG. 5 is a perspective view of another object to be temperature-conditioned according to the first exemplary embodiment of the present invention.

FIG. 6 is a perspective view illustrating another structural example of the temperature conditioning unit according to the first exemplary embodiment of the present invention.

FIG. 7 is a schematic system configuration diagram of a temperature conditioning system according to a second exemplary embodiment of the present invention.

FIG. 8 is a schematic system configuration diagram of another temperature conditioning system according to the second exemplary embodiment of the present invention.

FIG. 9 is a schematic system configuration diagram of still another temperature conditioning system according to the second exemplary embodiment of the present invention.

FIG. 10 is a schematic view of a vehicle according to the second exemplary embodiment of the present invention.

FIG. 11 is a schematic view of another vehicle according to the second exemplary embodiment of the present invention.

FIG. 12 is a sectional view of a conventional temperature conditioning unit.

### DESCRIPTION OF EMBODIMENTS

The present invention is described hereinafter with reference to the accompanying drawings. It is to be noted that the following exemplary embodiments are not restrictive of the present invention. It is also to be noted that outlined arrows in the drawings are displayed as required to schematically indicate an air flow.

### First Exemplary Embodiment

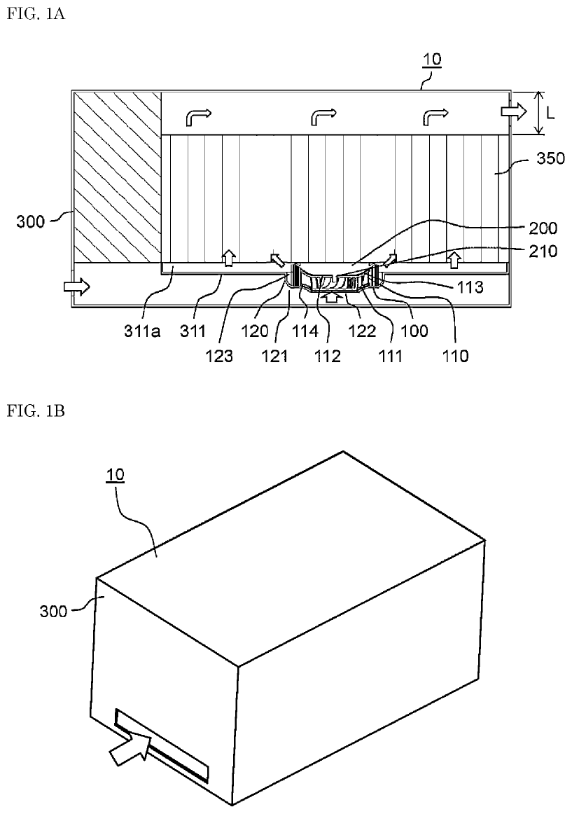

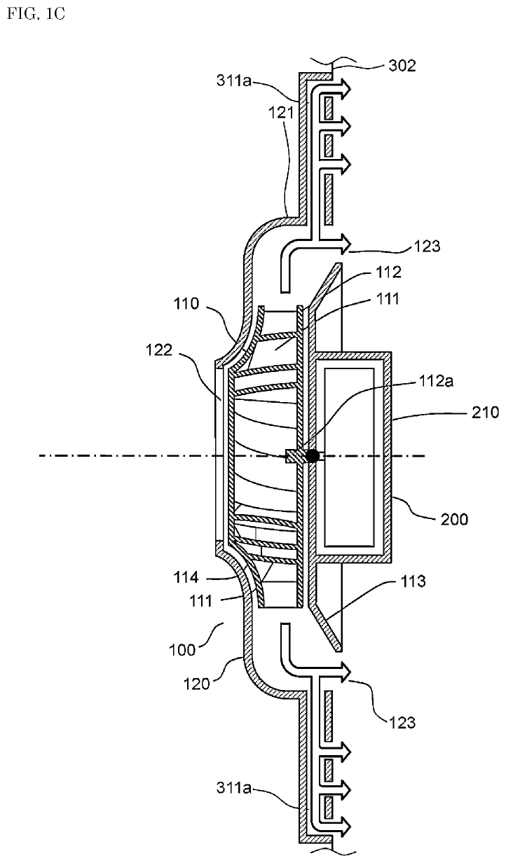

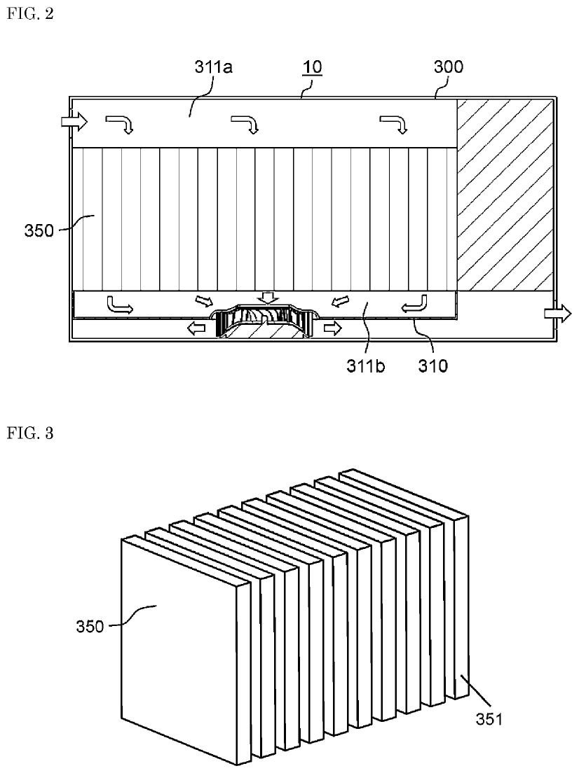

FIG. 1A is a sectional view of temperature conditioning unit 10 according to the first exemplary embodiment of the present invention. FIG. 1B is a perspective view of temperature conditioning unit 10. FIG. 1C is an enlarged view of an essential portion of the temperature conditioning unit shown in FIG. 1A. FIG. 2 is a sectional view illustrating another structural example of temperature conditioning unit 10 according to the first exemplary embodiment of the present invention. Temperature conditioning unit 10 is sheathed with housing 300. Housing 300 includes outer surface 302 that is mounted with fan case 120. Housing 300 accommodates constituent elements that are described below. Blower 100 is a centrifugal blower element and includes impeller (centrifugal fan) 110 having a plurality of rotor vanes 111 and substantially disk-shaped impeller disk 112 connecting rotor vanes 111, and fan case 120 that has substantially cylindrical side wall 121 formed to be centered about a rotating shaft of impeller 100 and intake hole 122 that is circular on a plane perpendicular to the rotating shaft and is centered about the rotating shaft. Impeller 110 is fixedly connected via shaft 210 to electric motor 200 that is a rotary drive source. Electric motor 200 used as the rotary drive source includes shaft 210.

As electric motor 200 used as the rotary drive source is rotationally driven, impeller 110 rotates, whereby air that flows into fan case 120 from intake hole 122 and is energized by rotor vanes 111 is discharged in a direction substantially perpendicular to the rotating shaft. Side wall 121 of fan case 120 has a first airflow guide shape, thus changing the direction of a discharged flow to a counter intake direction with respect to the rotating shaft. It is to be noted that an inner wall of side wall 121 is preferably shaped into a gently curved surface so as not to obstruct the air flow. The substantially uniform air flow discharged from discharge hole 123 of fan case 120 is fed into housing 300, thus cooling or warming object 350 to be temperature-conditioned that is a component such as a battery pack and is disposed inside housing 300. Discharge hole 123 is positioned on an opposite end of side wall 121 from intake hole 122 in a direction along the rotating shaft.

Impeller 110 includes substantially disk-shaped impeller disk 112 that includes, in its center, the rotating shaft of electric motor 200 used as the rotary drive source and is disposed on a plane perpendicular to the rotating shaft, and the plurality of rotor vanes 111 erected on an intake-hole-end surface of impeller disk 112. Impeller 110 further includes shroud 114. An aspect of shroud 114 is that shroud 114 is an annular plate covering respective intake-hole-end edges of rotor vanes 111 of impeller 110. Shroud 114 is funnel-shaped, bell-shaped, or trumpet-shaped, having a hole in its center. A wider mouth of shroud 114 faces impeller disk 112, while a narrower mouth of shroud 114 faces the intake hole. Impeller disk 112 includes, along its outer-peripheral end, slope 113 that inclines toward an air supply direction, thereby reducing resistance to the air flow.

In a conventional method, a blower mechanism is disposed near a heat generator when air is blown against an object to be temperature-conditioned. However, in an electric apparatus in which an object to be temperature-conditioned is large with respect to a housing with a plurality of heat generators being densely disposed as in the case of the present exemplary embodiment, air flow resistance, that is to say, pressure loss increases. Accordingly, in cases where the object to be temperature-conditioned occupies a large volume of the housing, an intake-side chamber is provided at the object to be temperature-conditioned, and an exhaust-side chamber is provided at the object to be temperature-conditioned. With these chambers, the air is approximately uniformly blown against the object to be temperature-conditioned. The intake-side chamber and the exhaust-side chamber are often limited to a minimum area each for size reduction of the electric apparatus. On the other hand, the housing has high ventilation resistance, so that high output is required of the blower mechanism, thus naturally causing increase in size of the blower mechanism. Consequently, it is difficult to accommodate the blower mechanism in the housing. As such, the blower mechanism is generally placed externally to the housing, and a passage is formed by a duct or the like that connects a discharge hole of a blower and an inflow port of the housing. For this reason, it is difficult to achieve size reduction of the electric apparatus including the object to be temperature-conditioned and a temperature conditioning system.

On the other hand, temperature conditioning unit 10 of the present exemplary embodiment enables passage of sufficient cooling air even when its intake-side chamber and its exhaust-side chamber each have an aspect of flat shape, by adopting the centrifugal blower element of high static pressure. Blower 100 that is the centrifugal blower element may be disposed in either or both of the intake-side chamber and the exhaust-side chamber. FIG. 1A illustrates an aspect in which blower 100 that is the centrifugal blower element is placed at isolation wall 311 defining intake-side chamber 311a. FIG. 1C is an enlarged view of the essential portion of the temperature conditioning unit shown in FIG. 1A. FIG. 2 illustrates an aspect in which blower 100 that is the centrifugal blower element is placed at isolation wall 311 defining exhaust-side chamber 311b. In temperature conditioning unit 10 of the present exemplary embodiment, the flow discharged from blower 100, which is the centrifugal blower element, gives less uneven flow velocity distribution to the housing. For this reason, an interior of housing 300 can effectively be temperature-conditioned even with a flow uniforming mechanism omitted. With the need for the flow uniforming mechanism such as a duct thus eliminated, pressure loss and friction loss that are otherwise caused at the flow uniforming mechanism are reduced. For this reason, higher efficiency of the blower, structural simplification, size reduction of an air conditioning system, and cost reduction resulting from a reduced parts count are enabled.

The constituent elements of impeller 110 according to the present exemplary embodiment can be formed of, but not specifically limited to, metal material or resin material.

Materials for a stator winding of the electric motor used as the rotary drive source include, but not specifically limited to, copper, copper alloy, aluminum, and aluminum alloy.

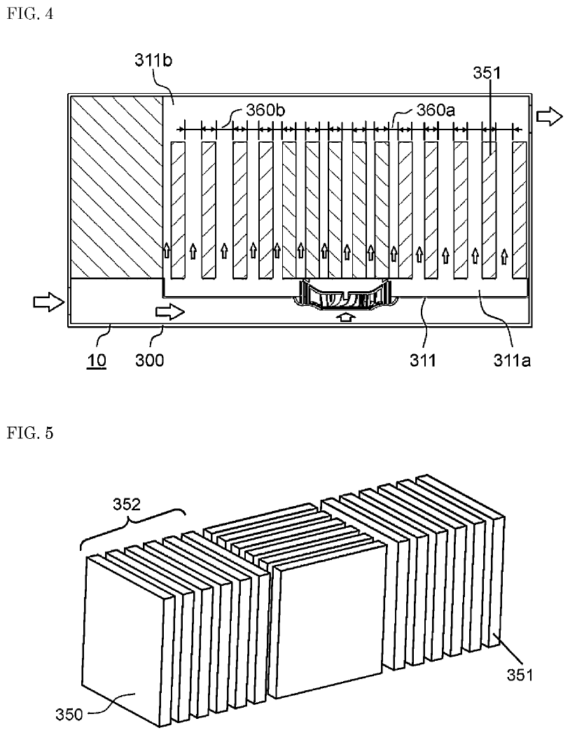

FIG. 3 is a perspective view of object 350 to be temperature-conditioned according to the first exemplary embodiment of the present invention. Object 350 to be temperature-conditioned is formed of a combination of substantially rectangular parallelepipeds (heat generators 351). The rectangular parallelepipeds are substantially equi-spaced with their maximum area surfaces being in opposed relationship. With the rectangular parallelepipeds being substantially equi-spaced, pressure resistance of the object to be temperature conditioned in the flowing direction of the cooling air is equalized even between heat generators 351 of the object to be temperature-conditioned. For this reason, sufficient areas can be ensured for intake-side chamber 311a and exhaust-side chamber 311b, respectively.

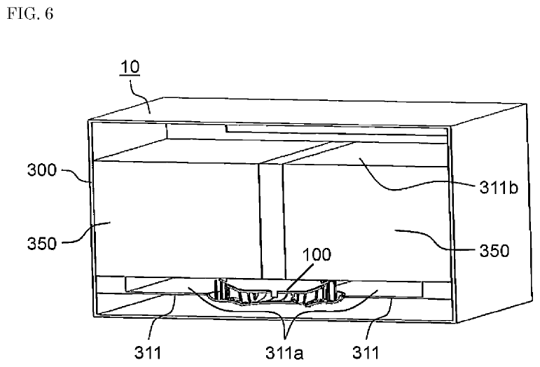

FIG. 4 is a sectional view illustrating still another structural example of temperature conditioning unit 10 according to the first exemplary embodiment of the present invention. FIG. 5 is a perspective view of another object 350 to be temperature conditioned according to the first exemplary embodiment of the present invention.

In cases where either or both of intake side chamber 311a and exhaust-side chamber 311b have respective narrow areas, greatly uneven flow velocity distribution is caused in intake side chamber 311a, thereby making a uniform flow of the cooling air through object 350 to be temperature-conditioned difficult. Accordingly, as shown in FIG. 4, parts that respectively face portions where the flow discharged from a blower is of high velocity have narrow spacing 360a between heat generators 351, while parts that respectively face portions where the flow discharged from the blower is of low velocity have wide spacing 360b between heat generators 351. In this way, adjustment of choice can be performed on pressure resistance of object 350 to be temperature-conditioned. Consequently, heat generators 351 can be cooled without nonuniformity. As shown in FIG. 5, blocks 352 to be temperature conditioned that are each formed of a plurality of heat generators 351 may be arranged to have different directions, respectively.

FIG. 6 is a perspective view illustrating another structural example of temperature conditioning unit 10 according to the first exemplary embodiment of the present invention. Temperature conditioning unit 10 of FIG. 6 is an electric apparatus in which intake side chamber 311a is formed of a plurality of spaces. Blower 100 is a centrifugal blower element and is disposed at isolation wall 311 forming a boundary of intake side chamber 311a. This eliminates the need for a discharged flow that faces an area of low flow velocity near a counter intake end surface of blower 100 which is the centrifugal blower element. Consequently, flow velocity distribution is easily rendered more uniform in intake side chamber 311a.

The above exemplary embodiment has been described on the assumption that the temperature conditioning unit might be used for a battery of a hybrid car but is not limited to this. Temperature conditioning unit 10 of the present exemplary embodiment is also applicable to temperature-conditioning of an engine control unit, an inverter device, an electric motor, and so on.

As described above, temperature conditioning unit 10 according to the present exemplary embodiment includes impeller 110, rotary drive source 200, fan case 120, housing 300, and at least one of intake-side chamber 311a at object 350 to be temperature-conditioned and exhaust-side chamber 311b at object 350 to be temperature-conditioned. Impeller 110 has substantially disk-shaped impeller disk 112 that includes rotating shaft 112a in its center and is disposed on the plane perpendicular to rotating shaft 112a, and the plurality of rotor vanes 111 erected on the intake-hole-end surface of impeller disk 112. Rotary drive source 200 includes shaft 210 and is connected to impeller 110 via shaft 210. Fan case 120 has substantially cylindrical side wall 121 formed to be centered about rotating shaft 112a, intake hole 122 that is circular on the plane perpendicular to rotating shaft 112a and is centered about rotating shaft 112a, and discharge hole 123 positioned on the opposite end of side wall 121 from intake hole 122 in the direction along rotating shaft 112a. Housing 300 includes outer surface 302 mounted with fan case 120 and accommodates object 350 to be temperature-conditioned.

Thus, temperature conditioning unit 10 that can be provided is of small size and is capable of efficient air-blowing even with respect to housing 300 containing the densely disposed components.

Object 350 to be temperature-conditioned may include at least one pair of heat generators 351 each of which is a substantially rectangular parallelepiped with the maximum-area surfaces of the rectangular parallelepipeds being in opposed relationship. Sufficient areas can thus be ensured for intake-side chamber 311a and exhaust-side chamber 311b, respectively.

Temperature conditioning unit 10 of the present exemplary embodiment may have both of intake-side chamber 311a and exhaust-side chamber 311b, and blower 100 for temperature-conditioning may be disposed in at least one of intake-side chamber 311a and exhaust-side chamber 311b. Thus, in temperature conditioning unit 10 of the present exemplary embodiment, the flow discharged from blower 100 that is the centrifugal blower element gives less uneven flow velocity distribution to the housing. For this reason, the interior of housing 300 can effectively be temperature-conditioned even with a flow uniforming mechanism omitted. With the need for the flow uniforming mechanism such as the duct thus eliminated, pressure loss and friction loss that are otherwise caused at the flow uniforming mechanism can be reduced. For this reason, the higher efficiency of the blower, the structural simplification, the size reduction of the air conditioning system, and the cost reduction resulting from the reduced parts count are enabled.

Temperature conditioning unit 10 of the present exemplary embodiment may have both of intake-side chamber 311a and exhaust-side chamber 311b, and respective volumes of intake-side chamber 311a and exhaust-side chamber 311b may be equal or different. For example, the volume of exhaust-side chamber 311b may be made smaller than the volume of intake-side chamber 311a. In this way, a value of pressure resistance of a plane facing object 350 to be temperature-conditioned in intake-side chamber 311a and a value of pressure resistance of a plane facing object 350 to be temperature-conditioned in exhaust-side chamber 311b are adjusted, whereby heat generators 351 can be cooled without nonuniformity.

Temperature conditioning unit 10 of the present exemplary embodiment may further include rotary drive source 200 that rotationally drives rotating shaft 112a of impeller 110. The stator winding of rotary drive source 200 may include any one of copper, copper alloy, aluminum, and aluminum alloy.

Impeller 110 may include metal or resin.

### Second Exemplary Embodiment

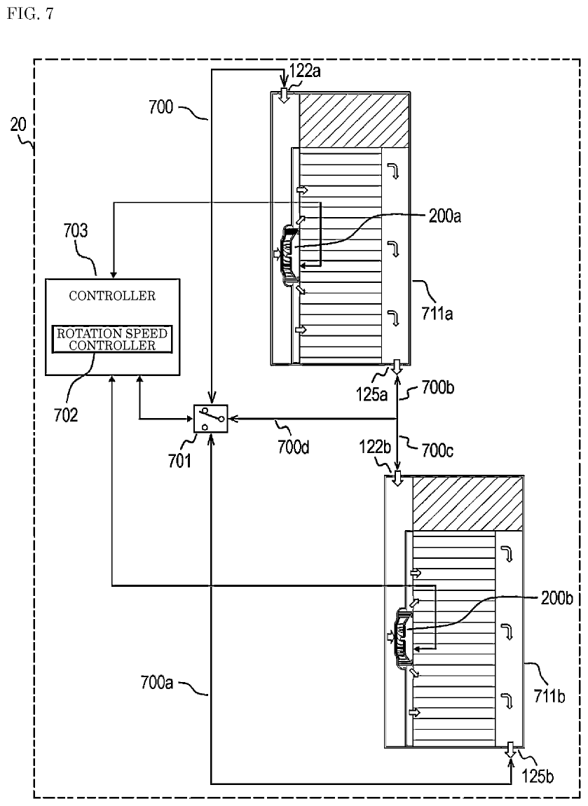

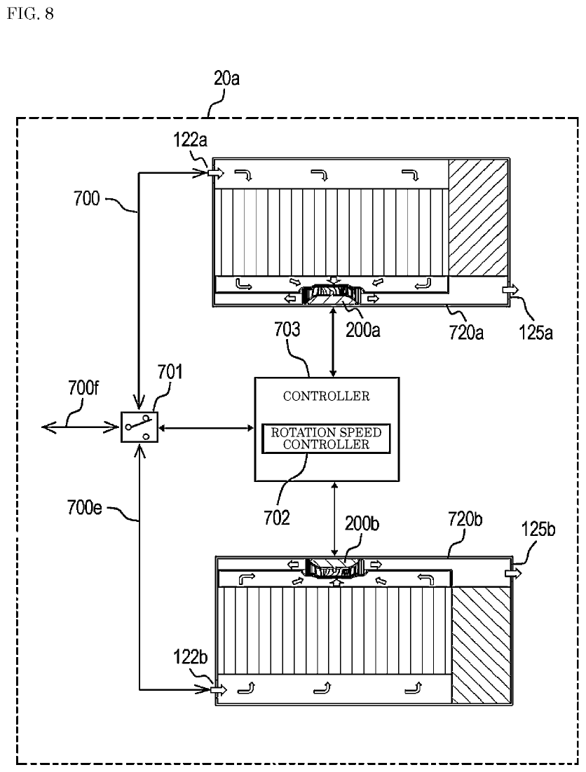

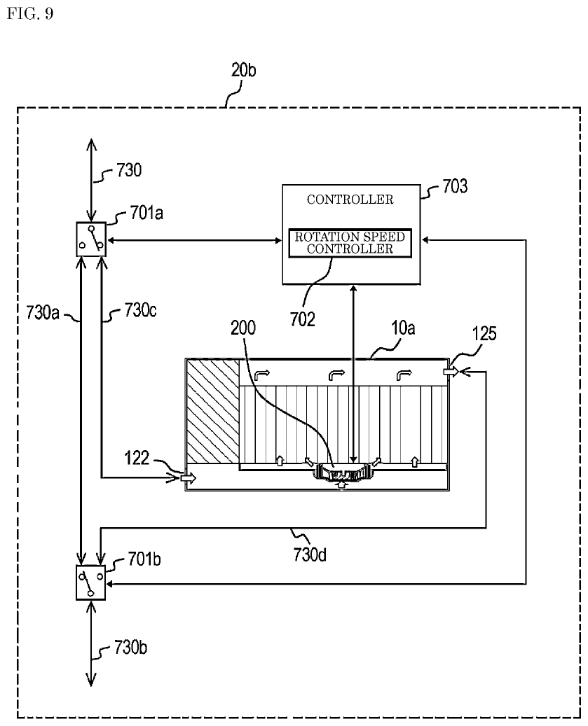

FIG. 7 is a schematic system configuration diagram of temperature conditioning system 20 according to a second exemplary embodiment of the present invention. FIG. 8 is a schematic system configuration diagram of another temperature conditioning system 20a according to the second exemplary embodiment of the present invention. FIG. 9 is a schematic system configuration diagram of still another temperature conditioning system 20b according to the second exemplary embodiment of the present invention.

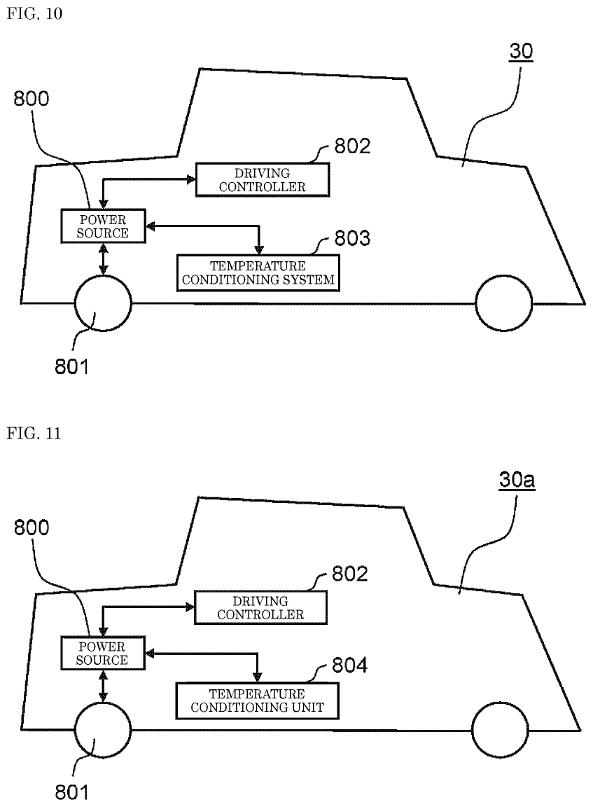

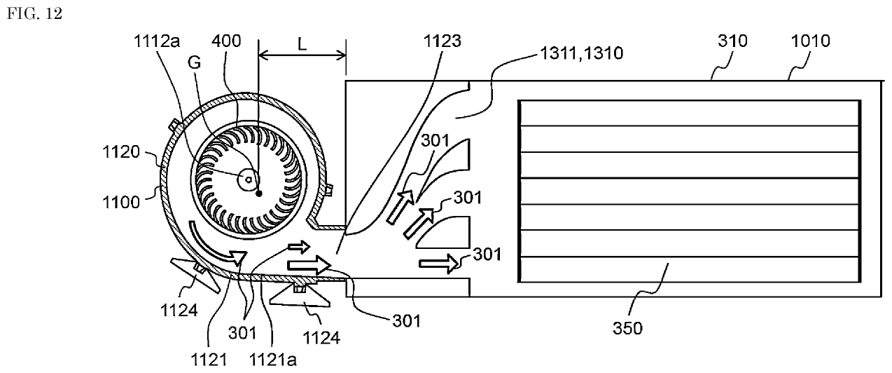

FIG. 10 is a schematic view of vehicle 30 according to the second exemplary embodiment of the present invention. FIG. 11 is a schematic view of another vehicle 30a according to the second exemplary embodiment of the present invention.

Structures similar to structures of the temperature conditioning unit of the first exemplary embodiment have the same reference marks, and the descriptions of the structures of the temperature conditioning unit of the first exemplary embodiment are applied by analogy to these structures.

As shown in FIGS. 7 to 9, the temperature conditioning systems according to the second exemplary embodiment are each structured as follows.

Temperature conditioning system 20 according to the second exemplary embodiment includes, as shown in FIG. 7, first temperature conditioning unit 711a, second temperature conditioning unit 711b, a plurality of ducts 700, 700a, 700b, 700c, and 700d, switching unit 701, rotation speed controller 702, and controller 703.

Temperature conditioning units 10 described in the first exemplary embodiment can be used as first temperature conditioning unit 711a and second temperature conditioning unit 711b. Each of the temperature conditioning units shown in FIG. 7 is the one described with reference to FIG. 1A in the first exemplary embodiment.

Among the plurality of ducts, ducts 700b, 700c connect exhaust hole 125a of first temperature conditioning unit 711a and intake hole 122b of second temperature conditioning unit 711b. Intake hole 122b draws air into the housing. Exhaust hole 125a is where the drawn air is discharged out of the housing.

Alternatively, among the plurality of ducts, ducts 700, 700a connect intake hole 122a of first temperature conditioning unit 711a and exhaust hole 125b of second temperature conditioning unit 711b.

Switching unit 701 changes a connection state among ducts 700, 700a, and 700d.

Rotation speed controller 702 controls at least one of rotation speed of electric motor 200a of first temperature conditioning unit 711a and rotation speed of electric motor 200b of second temperature conditioning unit 711b.

Controller 703 controls switching unit 701 and rotation speed controller 702. This controller 703 controls passages of air flowing through the plurality of ducts 700, 700a, 700b, 700c, and 700d or volumes of the air.

As shown in FIG. 8, temperature conditioning system 20a according to the second exemplary embodiment includes first temperature conditioning unit 720a, second temperature conditioning unit 720b, a plurality of ducts 700, 700e, and 700f, switching unit 701, rotation speed controller 702, and controller 703.

The temperature conditioning units described in the first exemplary embodiment can be used as first temperature conditioning unit 720a and second temperature conditioning unit 720b. Each of the temperature conditioning units shown in FIG. 8 is the one described with reference to FIG. 1B in the first exemplary embodiment.

Among the plurality of ducts, ducts 700, 700e connect intake hole 122a of first temperature conditioning unit 720a and intake hole 122b of second temperature conditioning unit 720b.

Alternatively, the plurality of ducts 700, 700e, and 700f may connect exhaust hole 125a of first temperature conditioning unit 720a and exhaust hole 125b of second temperature conditioning unit 720b.

Switching unit 701 changes a connection state among the plurality of ducts 700, 700e, and 700f.

Rotation speed controller 702 controls at least one of rotation speed of electric motor 200a of first temperature conditioning unit 720a and rotation speed of electric motor 200b of second temperature conditioning unit 720b.

Controller 703 controls switching unit 701 and rotation speed controller 702. This controller 703 controls passages of air flowing through the plurality of ducts 700, 700e, and 700f or volumes of the air.

Alternatively, temperature conditioning system 20b according to the second exemplary embodiment includes, as shown in FIG. 9, temperature conditioning unit 10a, first ducts 730, 730a, and 730b, second ducts 730c, 730d, switching units 701a, 701b, rotation speed controller 702, and controller 703.

Each of the temperature conditioning units described in the first exemplary embodiment can be used as temperature conditioning unit 10a. The temperature conditioning unit shown in FIG. 9 is the one described with reference to FIG. 1B in the first exemplary embodiment.

Through first ducts 730, 730a, and 730b, air passes but not through temperature conditioning unit 10a.

Through second duct 730c, air passes to be fed to temperature conditioning unit 10a. The air discharged from temperature conditioning unit 10a passes through second duct 730d. It is to be noted that the air is drawn in from intake hole 122 and is discharged from exhaust hole 125.

First ducts 730, 730a, and 730b and second ducts 730c, 730d are connected to switching units 701a, 701b. Switching units 701a, 701b perform switching between air flows.

Rotation speed controller 702 controls at least rotation speed of electric motor 200 of temperature conditioning unit 10a.

Controller 703 controls switching units 701a, 701b and rotation speed controller 702. This controller 703 controls passages of the air flowing through first ducts 730, 730a, and 730b and second ducts 730c, 730d or volumes of the air.

FIG. 10 is a schematic view of vehicle 30 according to the second exemplary embodiment of the present invention. Vehicle 30 includes power source 800, drive wheels 801, driving controller 802, and temperature conditioning system 803.

Drive wheels 801 are driven by power supplied from power source 800. Driving controller 802 controls power source 800. Each of temperature conditioning systems 20, 20a, and 20b described above can be used as temperature conditioning system 803.

FIG. 11 is a schematic view of another vehicle 30a according to the second exemplary embodiment of the present invention. Vehicle 30a includes power source 800, drive wheels 801, driving controller 802, and temperature conditioning unit 804.

Drive wheels 801 are driven by power supplied from power source 800. Driving controller 802 controls power source 800. Each of the temperature conditioning units described in the first exemplary embodiment can be used as temperature conditioning unit 804.

Further details are explained with reference to FIGS. 10 and 11.

As shown in FIG. 10, temperature conditioning system 803 of the second exemplary embodiment is mounted to vehicle 30. By adopting the following configuration, temperature conditioning system 803 effectively cools and warms a member to be temperature-conditioned when mounted to vehicle 30.

A plurality of the temperature conditioning units of the foregoing exemplary embodiment can be used in temperature conditioning system 803 of the second exemplary embodiment. Temperature conditioning system 803 includes a plurality of ducts connecting intake holes and vent holes of the temperature conditioning units. Temperature conditioning system 803 includes a switching unit that changes an amount of air flowing through the ducts or an air flow path.

For example, the temperature conditioning units are connected by the ducts in cases where intake-side temperature is lower than ordinary temperature. With this configuration, the member to be temperature-conditioned can efficiently be temperature-conditioned.

Alternatively, temperature conditioning system 803 has a plurality of ducts respectively connected to an intake hole and a vent hole of the temperature conditioning unit. This temperature conditioning system 803 includes switching units that change an amount of air flowing through the ducts or an air flow path.

For example, the plurality of ducts is respectively connected to the intake hole and the vent hole of the temperature conditioning unit.

As shown in FIG. 9, duct 730 has one end connected outwardly of the vehicle and another end connected to switching unit 701a. Duct 730a has one end connected to switching unit 701a and another end connected to switching unit 701b. Duct 730c has one end connected to switching unit 701a and another end connected to intake hole 122 of temperature conditioning unit 10a.

Duct 730d has one end connected to exhaust hole 125 of temperature conditioning unit 10a and another end connected to switching unit 701b.

In cases where temperature outside vehicle 30 falls within a predetermined range, outside air can be introduced directly into vehicle 30 through the ducts in this configuration. In cases where the temperature outside vehicle 30 falls outside the predetermined range, the outside air can be introduced into vehicle 30 through the ducts and the temperature conditioning unit.

In other words, temperature conditioning system 803 can change air that is provided to a member to be temperature-conditioned according to the temperature outside the vehicle. Thus, temperature conditioning system 803 can efficiently temperature-condition the member to be temperature-conditioned while saving energy.

It is to be noted that in this temperature conditioning system 803, a threshold of the temperature outside the vehicle that is used for duct switching may be set appropriately according to a purpose. Moreover, the intake of the air from outside the vehicle that is associated with the duct switching can be done by switching that is based on atmospheric pressure instead of the temperature outside the vehicle in temperature conditioning system 803.

The description of the vehicle shown in FIG. 10 can be applied by analogy to the vehicle shown in FIG. 11 by replacing temperature conditioning system 803 with temperature conditioning unit 804.

As such, the temperature conditioning unit of the present exemplary embodiment further includes an exhaust hole where air that is drawn into a housing is discharged out of the housing. In this way, the air drawn into the housing can be discharged out of the housing.

As described above, temperature conditioning system 20 or 20a of the present exemplary embodiment includes the first temperature conditioning unit, the second temperature conditioning unit, and the plurality of ducts connecting exhaust hole 122a or intake hole 125a of the first temperature conditioning unit and intake hole 122b or exhaust hole 125b of the second temperature conditioning unit. Moreover, the temperature conditioning system of the present exemplary embodiment includes the switching unit that changes the connection state among the plurality of ducts, rotation speed controller 702 that controls the at least one of the rotation speed of the rotary drive source of the first temperature conditioning unit and the rotation speed of the rotary drive source of the second temperature conditioning unit, and controller 703 that controls the switching unit and rotation speed controller 702 for controlling the passages of the air flowing through the plurality of ducts or the volumes of the air. The temperature conditioning system of the present exemplary embodiment can thus efficiently temperature condition a member to be temperature conditioned while saving energy.

Temperature conditioning system 20b of the present exemplary embodiment includes temperature conditioning unit 10a, first ducts 730, 730a, and 730b through which air passes but not through temperature conditioning unit 10a, second duct 730c, 730d through which air passes to be fed to temperature conditioning unit 10a or the air discharged from temperature conditioning unit 10a passes, and switching units 701a, 701b that are connected to the first ducts and the second ducts and perform the switching between the air flows. Moreover, temperature conditioning system 20b of the present exemplary embodiment includes rotation speed controller 702 that controls the rotation speed of the rotary drive source of temperature conditioning unit 10a, and controller 703 that controls switching units 701a, 701b and rotation speed controller 702 for controlling the passages of the air flowing through the plurality of ducts or the volume of the air. This temperature conditioning system of the present exemplary embodiment can thus efficiently temperature condition a member to be temperature conditioned while saving energy.

Vehicle 30 of the present exemplary embodiment includes power source 800, drive wheels 801 that are driven by the power supplied from power source 800, driving controller 802 that controls power source 800, and temperature conditioning system 803. In this way, temperature conditioning system 803 can change air that is provided to the member to be temperature conditioned according to the temperature outside the vehicle. Thus, temperature conditioning system 803 can efficiently temperature condition the member to be temperature conditioned while saving energy.

Vehicle 30a includes power source 800, drive wheels 801 that are driven by the power supplied from power source 800, driving controller 802 that controls power source 800, and temperature conditioning unit 804. In this way, temperature conditioning unit 804 can change air that is provided to a member to be temperature conditioned according to the temperature outside the vehicle. Thus, temperature conditioning unit 804 can efficiently temperature condition the member to be temperature conditioned while saving energy.

### INDUSTRIAL APPLICABILITY

A temperature conditioning unit and a temperature conditioning system according to the present invention are susceptible of size reduction, increase in output and increase in efficiency and are useful in, for example, temperature conditioning a vehicle mounted battery. When mounted to a vehicle, the temperature conditioning unit and the temperature conditioning system of the present invention do not cause excessive vibration and noise.

### REFERENCE MARKS IN THE DRAWINGS

10: temperature conditioning unit

10a: temperature conditioning unit

20: temperature conditioning system

20a: temperature conditioning system

20b: temperature conditioning system

30: vehicle

30a: vehicle

100: blower

110: impeller (centrifugal fan)

111: rotor vane

112: impeller disk

112a: rotating shaft

113: slope

114: shroud

120: fan case

121: side wall

122: intake hole

122a: intake hole

122b: intake hole

123: discharge hole

125: exhaust hole

125a: exhaust hole

125b: exhaust hole

200: electric motor

200a: electric motor

200b: electric motor

210: shaft

300: housing

302: outer surface

311: isolation wall

311a: intake side chamber

311b: exhaust-side chamber

350: object to be temperature conditioned

351: heat generator

352: block to be temperature conditioned

360a: spacing

360b:spacing

700: duct

700a: duct

700b: duct

700c: duct

700d: duct

700e: duct

700f: duct

701: switching unit

701a: switching unit

701b: switching unit

702: rotation speed controller

703: controller

711a: first temperature conditioning unit

711b: second temperature conditioning unit

720a: first temperature conditioning unit

720b: second temperature conditioning unit

730: first duct

730a: first duct

730b: first duct

730c: second duct

730d: second duct

800: power source

801: drive wheel

802: driving controller

803: temperature conditioning system

804: temperature conditioning unit

L: distance

1. A temperature conditioning unit comprising:
an impeller including
an impeller disk that is substantially disk-shaped, the impeller disk including a rotating shaft in a center of the impeller disk and being disposed on a plane perpendicular to the rotating shaft, and
a plurality of rotor vanes erected on an intake-hole-end surface of the impeller disk;
a rotary drive source including a shaft, the rotary drive source being connected to the impeller via the shaft;
a fan case including
a side wall that is substantially cylindrical, the side wall being formed to be centered about the rotating shaft,
an intake hole that is circular on a plane perpendicular to the rotating shaft, the intake hole being centered about the rotating shaft, and
a discharge hole positioned on an opposite end of the side wall from the intake hole in a direction along the rotating shaft;
a housing including an outer surface mounted with the fan case, the housing accommodating an object to be temperature-conditioned; and
at least one of an intake side chamber at the object to be temperature conditioned and an exhaust-side chamber at the object to be temperature-conditioned.

2. The temperature conditioning unit according to claim 1, further comprising
an exhaust hole where air that is drawn into the housing is discharged out of the housing.

3. The temperature conditioning unit according to claim 1, wherein
the object to be temperature conditioned includes at least one pair of heat generators that is substantially rectangular parallelepipeds with maximum-area surfaces of the rectangular parallelepipeds being in opposed relationship.

4. The temperature conditioning unit according to claim 1, comprising
both of the intake side chamber and the exhaust-side chamber,
wherein
a blower configured to temperature condition is disposed in the at least one of the intake side chamber and the exhaust-side chamber.

5. The temperature conditioning unit according to claim 1, comprising
both of the intake side chamber and the exhaust-side chamber,
wherein
respective volumes of the intake side chamber and the exhaust-side chamber are equal or different.

6. The temperature conditioning unit according to claim 1, further comprising
the rotary drive source configured to rotationally drive the rotating shaft of the impeller,
wherein
a stator winding of the rotary drive source includes any one of copper, copper alloy, aluminum, and aluminum alloy.

7. The temperature conditioning unit according to claim 1, wherein
the impeller includes one of metal and resin.

8. A temperature conditioning system comprising:
a first temperature conditioning unit that is the temperature conditioning unit of claim 2;
a second temperature conditioning unit that is the temperature conditioning unit of claim 2;
a plurality of ducts connecting one of the exhaust hole and the intake hole of the first temperature conditioning unit and one of the intake hole and the exhaust hole of the second temperature conditioning unit;
a switching unit configured to change a connection state among the plurality of ducts;
a rotation speed controller configured to control at least one of rotation speed of a rotary drive source of the first temperature conditioning unit and rotation speed of a rotary drive source of the second temperature conditioning unit; and
a controller configured to control the switching unit and the rotation speed controller to control passages of air flowing through the plurality of ducts or volumes of the air.

9. A temperature conditioning system comprising:
the temperature conditioning unit of claim 2;
a first duct configured to pass air, the first duct being free of mediation of the temperature conditioning unit;
a second duct configured to pass air that is fed to the temperature conditioning unit or is discharged from the temperature conditioning unit;
a switching unit configured to perform switching between air flows, the switching unit being connected to the first duct and the second duct;
a rotation speed controller configured to control rotation speed of a rotary drive source of the temperature conditioning unit; and
a controller configured to control the switching unit and the rotation speed controller to control passages of the air flowing through the first and second ducts or volumes of the air.

10. A vehicle comprising:
a power source;
a drive wheel that is driven by power supplied from the power source;
a driving controller configured to control the power source; and
the temperature conditioning system of claim 8 or 9.

11. A vehicle comprising:
a power source;
a drive wheel that is driven by power supplied from the power source;
a driving controller configured to control the power source; and
the temperature conditioning unit of claim 1 or 2.
